(19) United States
(12) Patent Application Publication
(10) Pub. No.: US 2026/0203573 A1
(43) Pub. Date: Jul. 16, 2026

(54) PREDICTION DEVICE, PREDICTION METHOD, AND COMPUTER-READABLE MEDIUM

(71) Applicant: NEC Corporation, Tokyo (JP)

(72) Inventors: Murtuza PETLADWALA, Tokyo (JP); Takahiro KUMURA, Tokyo (JP); Yoshiyuki YAJIMA, Tokyo (JP)

(73) Assignee: NEC Corporation, Tokyo (JP)

(21) Appl. No.: 19/135,419

(22) PCT Filed: Dec. 8, 2022
(86) PCT No.: PCT/JP2022/045309

§ 371 Date: Jun. 4, 2025

(51) Int. Cl. G06N 3/08; G06N 3/0455

(52) U.S. Cl. CPC G06N 3/08; G06N 3/0455

(57) ABSTRACT

A prediction device comprises: an extraction unit (11) that extracts a first and second multi-dimensional feature including a feature of each of a plurality of frequency components included in a time-series signal of a first sensor and a second sensor respectively; a training unit (12) that inputs the first multi-dimensional feature into an encoder and the second multi-dimensional feature into a decoder, wherein a transformer model including the encoder and the decoder learns the relationship between the first multi-dimensional feature and the second multi-dimensional feature; a prediction unit (13) that inputs the first multi-dimensional feature into the encoder, wherein a learned transformer model predicts and outputs the second multi-dimensional feature and a reconstruction unit (14) that generates the time-series signal of the second sensor based on the second multi-dimensional feature obtained from outputting of the transformer model.

### TECHNICAL FIELD

The present disclosure relates to a prediction device, prediction method, and a computer readable medium.

### BACKGROUND ART

Heavy traffic load on a bridge leads to faster aging and increases the rate of deterioration. Bridge health can be monitored by displacement signals. Displacement signals are major indicators of bridge damage and internal structural characteristics. Because acceleration sensors (accelerometers) have a longer life span than displacement sensors (e.g., strain gauges), it is desirable to predict the time-series signal of the displacement sensor from the time-series signal of the accelerometer.

Non-Patent Literature 1 discloses a technique for calculating the displacement signals from the acceleration signals. The displacement x is expressed as

$$\begin{matrix}( equation 1 ) & \\ x = Acos ( ω t + φ ) & ( 1 )\end{matrix}$$

“A” stands for amplitude, “φ” for initial phase, “ω” for frequency and “t” for time. The velocity v is expressed as

$$\begin{matrix}( equation 2 ) & \\ v = \frac{dx}{dt} = - ω Asin ( ω t + φ ) & ( 2 )\end{matrix}$$

The acceleration a is expressed as

$$\begin{matrix}( equation 3 ) & \\ a = \frac{{d}^{2} x}{{dt}^{2}} = - {ω}^{2} Acos ( ω t + φ ) & ( 3 )\end{matrix}$$

Theoretically, displacement “x” can be calculated by numerically integrating the acceleration “a” twice.

Non-Patent Literature 2 discloses a technique for estimating the displacement signals from acceleration signals by using a Kalman filter.

Non-Patent Literature 3 discloses a technique for predicting the displacement signals by using a convolutional neural network. The displacement signals are estimated from the acceleration signals by having the U-net, a convolutional neural network, learn the relationship between the acceleration signals and the signals obtained by numerically integrating the acceleration signals twice.

### CITATION LIST

### Non Patent Literature

NPL 1: H. Sekiya et. al., “Technique for Determining Bridge Displacement Response Using MEMS Accelerometers”, Sensors, 2016
NPL 2: T. Nagayama et. Al., “A numerical study on bridge deflection estimation using multi-channel acceleration measurement”, Journal of Structural Engineering, 2017
NPL 3: Atta et. al., “Estimation of highway bridges' deflection from acceleration measurement by using a machine learning approach”, JSCE 2022

### SUMMARY OF INVENTION

### Technical Problem

Regarding to NPL1, the displacement signal cannot be accurately calculated because noise in the acceleration signal is accumulated while obtaining the twice numerical integrations, in addition there is high uncertainty regarding the integral boundary conditions of the numerical integration that is critical to vehicle entry and exit time information.

Regarding to NPL2, modal information such as the mode shape and structural information about the position where the sensor is attached are required. In addition, tuning hyperparameters for Kalman filtering model is difficult due to uncertainty of signal and noise distributions in the signal and even after fine tuning the hyperparameters there is a problem of dynamic bias that is observed in the estimated displacement signals.

Regarding to NPL3, the convolutional filter makes it impossible to learn complex relationships over long periods of time. In addition, to understand the behavior of N-dimensional time-series signal, multiple-channel signals from accelerometers and inclinometers are required. In addition, there is a problem that complicated temporal changes in bridge displacement due to complex traffic patterns cannot be predicted.

In view of the above, the purpose of this disclosure is to provide a prediction device, a prediction method, and a computer-readable medium that improve the accuracy of predicting the time-series signal of the second sensor from the time-series signal of the first sensor.

### Solution to Problem

A prediction device according to the present disclosure comprising:
extraction means for extracting a first and second multi-dimensional feature including a feature of each of a plurality of frequency components included in a time-series signal of a first sensor and a second sensor respectively;
training means for inputting the first multi-dimensional feature into an encoder and the second multi-dimensional feature into a decoder, wherein a transformer model including the encoder and the decoder learns the relationship between the first multi-dimensional feature and the second multi-dimensional feature;
prediction means for inputting the first multi-dimensional feature into the encoder, wherein a learned transformer model predicts and outputs the second multi-dimensional feature; and
reconstruction means for generating the time-series signal of the second sensor based on the second multi-dimensional feature obtained from outputting of the transformer model.

A prediction method according to the present disclosure comprising:
extracting a first and second multi-dimensional feature including a feature of each of a plurality of frequency components included in a time-series signal of a first sensor and a second sensor respectively;
inputting the first multi-dimensional feature into an encoder and the second multi-dimensional feature into a decoder, wherein a transformer model including the encoder and the decoder learns the relationship between the first multi-dimensional feature and the second multi-dimensional feature;
inputting the first multi-dimensional feature into the encoder, wherein a learned transformer model predicts and outputs the second multi-dimensional feature; and
generating the time-series signal of the second sensor based on the second multi-dimensional feature obtained from outputting of the transformer model.

A non-transitory computer readable medium according to the present disclosure storing a program for causing a computer to perform processes including:
extracting a first and second multi-dimensional feature including a feature of each of a plurality of frequency components included in a time-series signal of a first sensor and a second sensor respectively;
inputting the first multi-dimensional feature into an encoder and the second multi-dimensional feature into a decoder, wherein a transformer model including the encoder and the decoder learns the relationship between the first multi-dimensional feature and the second multi-dimensional feature;
inputting the first multi-dimensional feature into the encoder, wherein a learned transformer model predicts and outputs the second multi-dimensional feature; and
generating the time-series signal of the second sensor based on the second multi-dimensional feature obtained from outputting of the transformer model.

### Advantageous Effects of Invention

The prediction device, the prediction method and the computer readable medium according to the present disclosure can improve the accuracy of predicting the time-series signal of the second sensor from the time-series signal of the first sensor.

### BRIEF DESCRIPTION OF DRAWINGS

FIG. 1 is a block diagram illustrating the configuration of a prediction device according to a first example embodiment.

FIG. 2 is a block diagram illustrating the configuration of a prediction device according to a second example embodiment.

FIG. 3 is a schematic diagram illustrating the operation of a multi-dimensional feature extraction unit according to the second example embodiment.

FIG. 4 is a schematic diagram illustrating the operation of a transformer model according to the second example embodiment.

FIG. 5 is a graph illustrating the effect of the second example embodiment.

FIG. 6 is a graph illustrating the effect of the second example embodiment.

### DESCRIPTION OF EMBODIMENTS

Embodiments of the present disclosure will be described in detail below with reference to the drawings. In each drawing, the same or corresponding elements are denoted by the same reference sign, and duplicate explanations are omitted as necessary to clarify the description.

Example embodiments according to the present disclosure will be described hereinafter with reference to the drawings. Note that the following description and the drawings are omitted and simplified as appropriate for clarifying the explanation. Further, the same elements are denoted by the same reference numerals (or symbols) throughout the drawings, and redundant descriptions thereof are omitted as required. Also, in this disclosure, unless otherwise specified, “at least one of A or B (A/B)” may mean any one of A or B, or both A and B. Similarly, when “at least one” is used for three or more elements, it can mean any one of these elements, or any plurality of elements (including all elements). Further, it should be noted that in the description of this disclosure, elements described using the singular forms such as “a”, “an”, “the” and “one” may be multiple elements unless explicitly stated.

### First Example Embodiment

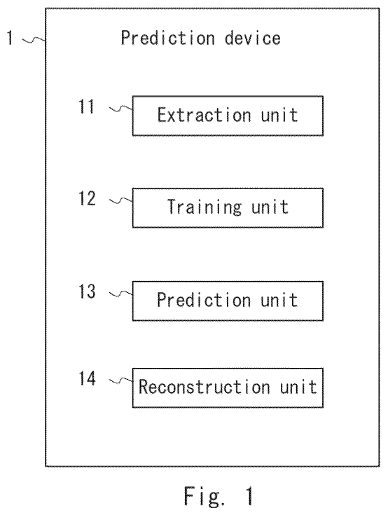

FIG. 1 is a block diagram showing the configuration of the prediction device 1 according to the first example embodiment. The prediction device 1 is equipped with an extraction unit 11, a training unit 12, a prediction unit 13 and a reconstruction unit 14.

The extraction unit 11 extracts a first and second multi-dimensional feature including a feature of each of a plurality of frequency components included in a time-series signal of a first sensor and a second sensor respectively.

A second sensor and the first sensor may be attached to a bridge. The first sensor and the second sensor are different types of sensors. They are not limited to a displacement sensor and an acceleration sensor. The first sensor and the second sensor may include an optical fiber cable attached to DAS (Distributed Acoustic Sensor) installed along the bridge.

The training unit 12 inputs the first multi-dimensional feature into an encoder and the second multi-dimensional feature into a decoder. A transformer model including the encoder and the decoder learns the relationship between the first multi-dimensional feature and the second multi-dimensional feature.

The prediction unit 13 inputs the first multi-dimensional feature into the encoder. A learned transformer model predicts and outputs the second multi-dimensional feature.

The reconstruction unit 14 generates the time-series signal of the second sensor based on the second multi-dimensional feature obtained from outputting of the transformer model.

Since the first multi-dimensional feature is extracted without using a convolutional filter, the prediction device 1 can predict the time-series signal of the second sensor accurately.

Herein, the prediction device 1 includes, as its components, a processor, a memory, and a storage device (none illustrated). The storage device stores a computer program that implements the processes of the monitoring method according to the present example embodiment. The processor loads the computer program from the storage device onto the memory and executes the computer program. Thus, the processor implements the functions of the extraction unit 11, the training unit 12, the prediction unit 13, and the reconstruction unit 14.

Alternatively, the extraction unit 11, the training unit 12, the prediction unit 13 and the reconstruction unit 14 may each be implemented by a dedicated piece of hardware. A part or the whole of the constituent elements of each device may be implemented by, for example, general-purpose or dedicated circuitry, a processor, or a combination thereof. Such constituent elements may be formed by a single chip or by a plurality of chips connected via a bus. A part or the whole of the constituent elements of each device may be implemented by a combination of the above-described circuitry or the like and a program. For the processor, a central processing unit (CPU), a graphics processing unit (GPU), a field-programmable gate array (FPGA), or the like can be used.

In a case where a part or the whole of the constituent elements of the prediction device 1 is implemented by a plurality of information processing devices, circuitries, or the like, these information processing devices, circuitries, or the like may be disposed centrally or distributed. For example, these information processing devices, circuitries, or the like may be implemented in a mode in which they are connected to each other via a communication network, as in, for example, a client server system or a cloud computing system. The function of the prediction device 1 may be provided in a Software as a Service (Saas) format.

### Second Example Embodiment

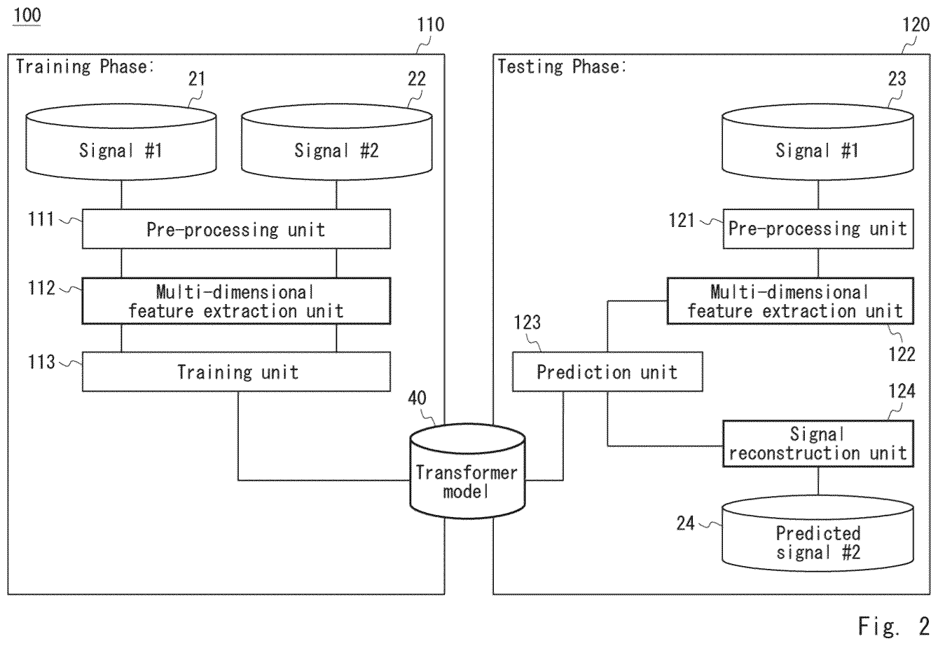

FIG. 2 is a diagram for explaining the configuration of the prediction device 100 according to the second example embodiment. This second example embodiment explains one of the specific examples of the first example embodiment, however, specific examples of the first example embodiment are not limited to this example embodiment.

The prediction device 100 includes a configuration 110 for training phase and a configuration 120 for testing phase. A transformer model 40 is trained by using the configuration 110. The transformer model 40 predicts the time-series signal of the second sensor by using the configuration 120. The prediction device 100 is one specific example embodiment of the prediction device 1.

The configuration 110 includes a pre-processing unit 111, a multi-dimensional feature extraction unit 112, and a training unit 113.

The pre-processing unit 111 resamples signal 21 measured from the first sensor for example, an acceleration sensor.

Similarly, the pre-processing unit 111 resamples signal 22 measured from the second sensor for example a displacement sensor.

The multi-dimensional feature extraction unit 112 is one specific example embodiment of the extraction unit 11. The multi-dimensional feature extraction unit 112 divides the original acceleration signal 21 into partial time-series signals by applying a sliding window of a predetermined length. The partial time series signal corresponds to the time series signal of the first sensor. The multi-dimensional feature extraction unit 112 divides the original displacement signal 22 into partial time-series signals by applying the sliding window of a predetermined length. The partial time series signal corresponds to the time series signal of the second sensor.

The multi-dimensional feature extraction unit 112 extracts the first multi-dimensional feature and the second multi-dimensional feature for training the transformer model 40. The multi-dimensional feature extraction unit 112 extracts the first multi-dimensional feature of the time-series signal of the first sensor by using a Fast Fourier Transform. The first multi-dimensional feature includes a feature of each of the plurality of frequency components included in the time-series signal of the first sensor. Similarly, the multi-dimensional feature extraction unit 112 extracts the second multi-dimensional feature of the time-series signal of the second sensor by using a Fast Fourier Transform. The multi-dimensional feature includes a feature of each of the plurality of frequency components included in the time-series signal of the second sensor.

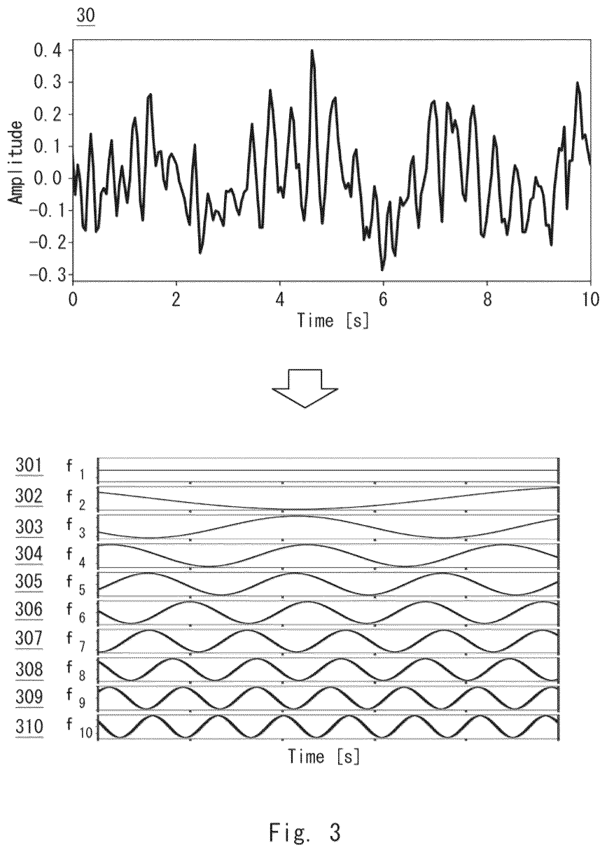

Referring to FIG. 3, the operation of the multi-dimensional feature extraction unit 112 will be described. The multi-dimensional feature extraction unit 112 performs a Fast Fourier Transform on a time-series signal 30 of the first sensor or the second sensor. The multi-dimensional feature extraction unit 112 decomposes the time-series signal 30 into frequency components 301-310 having frequencies f₁ to f₁₀. The multi-dimensional feature extraction unit 112 extracts the first multi-dimensional feature or the second multi-dimensional feature including a feature of each of the frequency components 301-310.

Referring to FIG. 2, the training unit 113 is one specific example embodiment of the training unit 12. The training unit 113 makes the transformer model 40 learn the relationship between the first multi-dimensional feature and the second multi-dimensional feature. The transformer model 40 includes an encoder and a decoder.

The configuration 120 includes a pre-processing unit 121, a multi-dimensional feature extraction unit 122, a prediction unit 123, and a signal reconstruction unit 124.

The preprocessing unit 121 removes noise from the time series signal 23 of the first sensor.

The multi-dimensional feature extraction unit 122 extracts a multi-dimensional feature from a time-series signal of the first sensor. The multi-dimensional feature extraction unit 122 performs the same processing as the multi-dimensional feature extraction unit 112. The multi-dimensional feature extraction unit 122 may performs the Fast Fourie Transform.

The prediction unit 123 is one specific example embodiment of the prediction unit 13. The prediction unit 123 inputs the first multi-dimensional feature of the time-series signal to the encoder of the transformer model 40. The prediction unit 123 acquires the second multi-dimensional feature output from the decoder of the transformer model 40.

The signal reconstruction unit 124 is one specific example embodiment of the reconstruction unit 13. The signal reconstruction unit 124 generates the time-series signal 24 of the second sensor based on the plurality of frequency components corresponding to the second multi-dimensional feature acquired from the decoder.

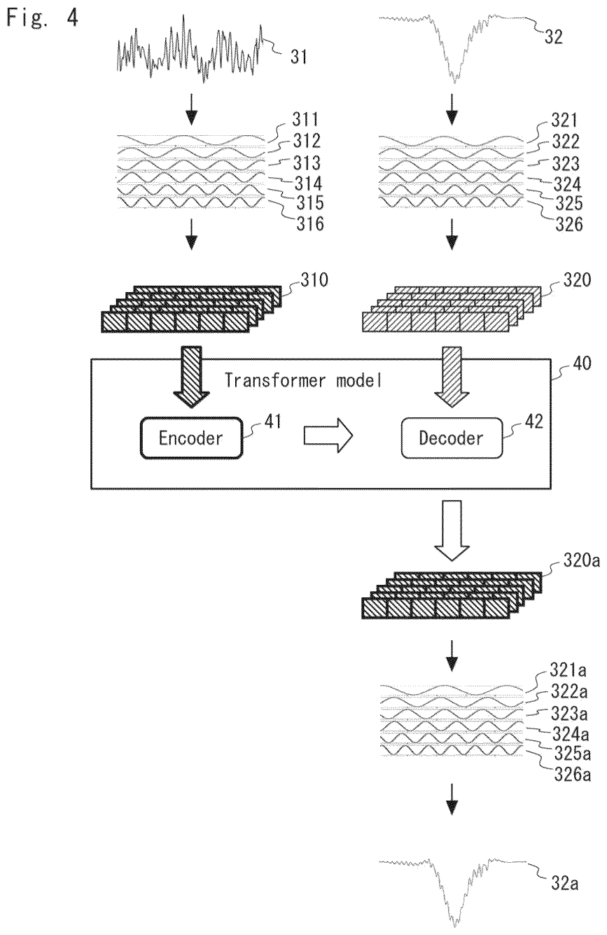

Referring to FIG. 4, the operation of the transformer model 40 will be described. First, the multi-dimensional feature extraction unit 112 of the prediction device 100 decomposes the time-series signal 31 into frequency components 311-316. The time-series signal 31 represents an acceleration signal. The multidimensional feature extraction unit 112 extracts the first multi-dimensional feature 310 from the frequency component 311-316. The first multi-dimensional feature 310 is represented by a matrix with six rows and six columns. For example, the first row contains six sample data from the frequency component 311.

Similarly, the multi-dimensional feature extraction unit 112 decomposes the time-series signal 32 into frequency components 321-326. The time-series signal 32 represents a displacement signal. The multi-dimensional feature extraction unit 112 extracts the second multi-dimensional feature 320 from the frequency component 321-326.

The training unit 113 of the prediction device 100 provides a first multi-dimensional feature 310 to the encoder 41 of the transformer model 40 and a second multi-dimensional feature 320 to the decoder 42 of the transformer model 40. The first multi-dimensional feature 310 and the second multi-dimensional feature 320 are corresponding to the same time instant. Thus, an encoder 41 and a decoder 42 are trained.

The prediction unit 123 of the prediction device 100 receives the second multi-dimensional feature 320a output from the decoder 42 after inputting the first multi-dimensional feature into the encoder 41.

The signal reconstruction unit 124 of the prediction device 100 generates frequency components 321a to 326a based on the second multi-dimensional feature 320a. The signal reconstruction unit 124 generates the time-series signal 32a of the second sensor by summing the frequency components 321a to 326a.

Referring to Equations (4), (5) and (6), the operation of the prediction device 100 will be described. The time-series signal y(t) in equation (4) contains the plurality of frequency components. fₛ represents the sampling frequency. fₙ represents the frequency. φₙ represents the phase.

$$\begin{matrix}( equation 4 ) & \\ y ( t ) = {A}_{i} + {\sum }_{n = 0}^{{f}_{s}} {A}_{n} sin ( 2 π {f}_{n} t + {φ}_{n} ) & ( 4 )\end{matrix}$$

The multi-dimensional feature extraction unit 122 extracts the first multi-dimensional feature from the time series signal y(t) by decomposing the time series signal y(t) into the plurality of frequency components expressed in equation (5).

$$\begin{matrix}( equation 5 ) & \\ y ( t ) = {A}_{0} sin ( 2 π {f}_{0} t + {φ}_{0} ) + {A}_{1} sin ( 2 π {f}_{1} t + {φ}_{1} ) + … + {A}_{k} sin ( 2 π {f}_{k} t + {φ}_{k} ) & ( 5 )\end{matrix}$$

The signal reconstruction unit 124 can generate the time-series signal y\hat{ }(t) from the second multi-dimensional feature by summing the plurality of frequency components as expressed in equation (6).

$$\begin{matrix}( equation 6 ) & \\ \hat{y} ( t ) = {\sum }_{n = 0}^{{f}_{s}} {A}_{n} sin ( 2 π {f}_{n} t + {φ}_{n} ) & ( 6 )\end{matrix}$$

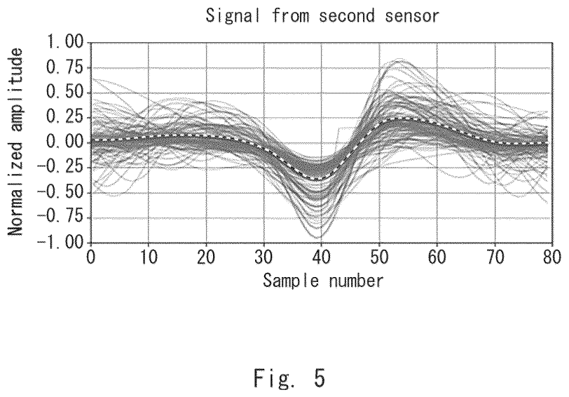

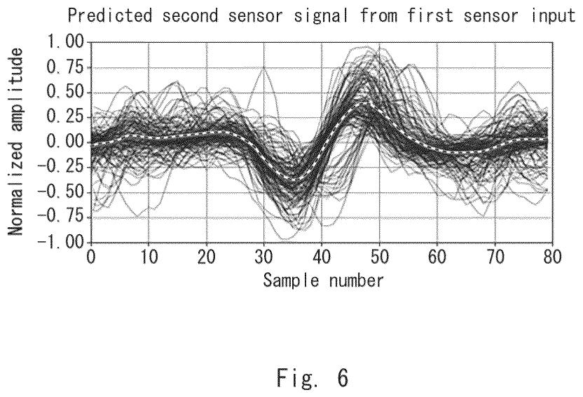

Referring to FIGS. 5 and 6, the effect of the second example embodiment will be described. FIG. 5 shows the actual displacement signal. The solid line represents the measured signal, while the dotted white line represents the average signal. The vertical axis represents the normalized signal strength, and the horizontal axis represents the sample (sampling) number, or time.

FIG. 6 shows the displacement signal estimated from the acceleration signal. The Displacement signals may be estimated from the vibration signals from DAS, or Rayleigh-based backscattering vibration signals. The displacement signal shown in FIG. 6 is close to the actual displacement signals shown in FIG. 5.

According to the second example embodiment, the displacement signal can be accurately predicted from the acceleration signal. The transformer model learns complex and long-term sequences because temporal dynamic behavior is decomposed into frequency dimensions. The transformer model also learns the inter-vibration relationship because inter-vibration frequencies (frequency components) possess an inherent strong correlation property. The second example embodiment can be applied to Bridge-Weigh-In-Motion and traffic volume estimation.

The program includes instructions (or software codes) that, when loaded into a computer, cause the computer to perform one or more of the functions described in the embodiments. The program may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray disc (®: Registered trademark) or other optical disk storage, magnetic cassettes, magnetic tape, magnetic disk storage or other magnetic storage devices. The program may be transmitted on a transitory computer readable medium or a communication medium. By way of example, and not limitation, transitory computer readable media or communication media can include electrical, optical, acoustical, or other form of propagated signals.

Various combinations and selections of various disclosed elements (including each element in each example, each element in each drawing, and the like) are possible within the scope of the claims of the present disclosure. That is, the present disclosure naturally includes various variations and modifications that could be made by those skilled in the art according to the overall disclosure including the claims and the technical concept.

### REFERENCE SIGNS LIST

1, 100 prediction device
11 extraction unit
12 training unit
13 prediction unit
14 reconstruction unit
110, 120 configuration
111, 121 pre-processing unit
112, 122 multi-dimensional feature extraction unit
123 prediction unit
124 signal reconstruction unit
30, 31, 32, 32a time-series signal
301-310, 311-316, 321-326, 321a-326a frequency component
40 transformer model
41 encoder
42 decoder

What is claimed is:

1. A prediction device comprising:
at least one memory storing instructions and
at least one processor configured to execute the instructions to:
extract a first and second multi-dimensional feature including a feature of each of a plurality of frequency components included in a time-series signal of a first sensor and a second sensor respectively;
input the first multi-dimensional feature into an encoder and the second multi-dimensional feature into a decoder, wherein a transformer model including the encoder and the decoder learns the relationship between the first multi-dimensional feature and the second multi-dimensional feature;
input the first multi-dimensional feature into the encoder, wherein a learned transformer model predicts and outputs the second multi-dimensional feature; and
generate the time-series signal of the second sensor based on the second multi-dimensional feature obtained from outputting of the transformer model.

2. The prediction device according to claim 1, wherein the first sensor is an acceleration sensor and the second sensor is a displacement sensor, where, theoretically, displacement signal is twice integration of the acceleration signal, this inherent correlation property between the sensor signals is learned and applied for prediction purpose.

3. The prediction device according to claim 2, wherein
the first sensor and the second sensor are attached to a bridge structure on a road highway for the purpose of monitoring systems determining bridge properties and traffic properties.

4. The prediction device according to claim 1, wherein the at least one processor is further configured to execute the instructions to extract the first multi-dimensional feature and the second multi-dimensional feature for training the transformer model after applying a sliding window of a predetermined length to an original time-series signal of the first sensor and an original time-series signal of the second sensor.

5. The prediction device according to claim 1, wherein the at least one processor is further configured to execute the instructions to extract the first and second multi-dimensional feature by performing a Fast Fourie Transform.

6. A prediction method comprising:
extracting a first and second multi-dimensional feature including a feature of each of a plurality of frequency components included in a time-series signal of a first sensor and a second sensor respectively;
inputting the first multi-dimensional feature into an encoder and the second multi-dimensional feature into a decoder, wherein a transformer model including the encoder and the decoder learns the relationship between the first multi-dimensional feature and the second multi-dimensional feature;
inputting the first multi-dimensional feature into the encoder, wherein a learned transformer model predicts and outputs the second multi-dimensional feature; and
generating the time-series signal of the second sensor based on the second multi-dimensional feature obtained from outputting of the transformer model.

7. A non-transitory computer readable medium storing a program for causing a computer to perform processes including:
extracting a first and second multi-dimensional feature including a feature of each of a plurality of frequency components included in a time-series signal of a first sensor and a second sensor respectively;
inputting the first multi-dimensional feature into an encoder and the second multi-dimensional feature into a decoder, wherein a transformer model including the encoder and the decoder learns the relationship between the first multi-dimensional feature and the second multi-dimensional feature;
inputting the first multi-dimensional feature into the encoder, wherein a learned transformer model predicts and outputs the second multi-dimensional feature; and
generating the time-series signal of the second sensor based on the second multi-dimensional feature obtained from outputting of the transformer model.
